(19) United States
(12) Patent Application Publication
(10) Pub. No.: US 2026/0223272 A1
(43) Pub. Date: Jul. 30, 2026

(54) LIGHT ENGINE CONTROL SYSTEM AND METHOD

(71) Applicant: Alcon Inc., Fribourg (CH)

(72) Inventors: Jing Xu, Irvine, CA (US); Hari Krishna Kapparapu, Irvine, CA (US); Dean Richardson, Aliso Viejo, CA (US)

(21) Appl. No.: 19/400,004

(22) Filed: Nov. 25, 2025

Related U.S. Application Data
(60) Provisional application No. 63/750,111, filed on Jan. 27, 2025.

(51) Int. Cl. H05B 47/175; H05B 45/20; H05B 45/325

(52) U.S. Cl. CPC H05B 47/196; H05B 45/20; H05B 45/325

(57) ABSTRACT

In certain embodiments, a method of controlling a light engine of an illumination system includes receiving, from a user input device, a desired color and a desired total flux output of a light engine; obtaining color signature data for each light emitting diode (LED) of the light engine; obtaining power flux data for each LED of the light engine; determining a power command for each LED based on the color signature data for each LED, the power flux data for each LED, the desired color, and the desired total flux output; and sending each power command to the LED to generate the desired color and the desired total flux output from the light engine. In certain embodiments, the light engine may include a red LED, a green LED, and a blue LED.

### INTRODUCTION

Ophthalmic surgery frequently requires precise cutting, removal, reshaping, etc. of the structures and tissues of the eye, such as cataract surgery, corneal surgery, etc. An ophthalmic surgeon may use an ophthalmic microscope system during many ophthalmic surgical procedures. The ophthalmic microscope system typically includes, or is typically used in conjunction with, an illumination system to illuminate the patient's eye, thereby allowing better visualization of the intraocular space through the microscope. The illumination system includes a light source, such as a halogen light, a light-emitting diode (LED), a light engine, etc. The illumination system may also include other optical elements, such as fiber optic cables (or optical fibers), collimating lens, etc., that facilitate the transmission of the light beam generated by the light source to the patient's eye.

### SUMMARY

In certain embodiments, a method of controlling a light engine of an illumination system includes receiving, from a user input device, a desired color and a desired total flux output of a light engine; obtaining color signature data for each light emitting diode (LED) of the light engine; obtaining power flux data for each LED of the light engine; determining a power command for each LED based on the color signature data for each LED, the power flux data for each LED, the desired color, and the desired total flux output; and sending each power command to the LED to generate the desired color and the desired total flux output from the light engine. In certain embodiments, the light engine may include a red LED, a green LED, and a blue LED.

### BRIEF DESCRIPTION OF THE DRAWINGS

FIG. 1 depicts a perspective view of an ophthalmic microscope system, in accordance with embodiments of the present disclosure.

FIG. 2A depicts a perspective view of the arms, the joint assemblies, and the optical head of the ophthalmic microscope system depicted in FIG. 1, in accordance with embodiments of the present disclosure.

FIG. 2B depicts a perspective view of a support frame for an illumination system, in accordance with embodiments of the present disclosure.

FIG. 2C depicts a perspective view of an illumination system, in accordance with embodiments of the present disclosure.

FIG. 3A depicts a perspective, cut away view of a light engine, and FIG. 3B depicts a diagram of an optical system of the light engine, in accordance with embodiments of the present disclosure.

FIG. 4 presents a block diagram of the control system and the illumination system of an ophthalmic microscope system, in accordance with embodiments of the present disclosure.

FIG. 5 depicts an example user interface for an ophthalmic microscope system, in accordance with embodiments of the present disclosure.

FIG. 6 depicts a graph presenting LED output brightness nonlinearity, in accordance with embodiments of the present disclosure.

FIG. 7 depicts a graph presenting light engine output brightness linearity, in accordance with embodiments of the present disclosure.

FIG. 8 depicts a graph presenting a Commission Internationale de l'éclairage (CIE) 1931 color map and a light engine color palette region, in accordance with embodiments of the present disclosure.

FIG. 9 depicts an example flow diagram presenting functionality associated with controlling a light engine of an illumination system, in accordance with certain embodiments of the present disclosure.

FIGS. 10A, 10B, 10C present measured CIE X, Y, and Z data and color signature values for a red LED, a green LED, and a blue LED, respectively, in accordance with embodiments of the present disclosure.

FIGS. 11A, 11B, 11C present measured LED output flux data and PWM signal data for a red LED, a green LED, and a blue LED, respectively, in accordance with embodiments of the present disclosure.

FIG. 12 presents color signature values, polynomial parameters, and maximum flux for the red, green, and blue LEDs described in FIGS. 10A, 10B, 10C, 11A, 11B, 11C, in accordance with embodiments of the present disclosure.

FIG. 13 presents example matrices D, Dᵣ, D_{g}, and D_{b}, in accordance with embodiments of the present disclosure.

### DETAILED DESCRIPTION

An LED generates a light beam that has a color (such as red, green, blue, etc.) and a brightness (also described as intensity or flux). A light engine may include two or more LEDs, such a red LED, a green LED, and a blue LED, etc., whose output light beams are optically combined to generate an output light beam. While the color of each LED light beam is not adjustable, the intensity of each LED light beam may be adjusted to generate a desired color and a desired intensity of the output light beam. For example, the light engine may consult a lookup table (LUT) that includes discrete entries that specify the intensity to set each LED light beam to generate a desired color and intensity of the output light beam. Unfortunately, the LUT requires a large amount of non-volatile memory for storage, and the LUT entries only provide a subset of the entire palette of colors and intensities that may be generated by the light engine.

Further complicating these technical issues, the intensity of an LED light beam is a nonlinear function of the current output by the drive circuit of the LED. The nonlinearity of the LED light beam intensity causes the color and intensity of the output light beam of the light engine to be nonlinear as well, which further prevents precise control of the color and intensity of the output light beam with respect to the desired color and intensity.

Accordingly, embodiments of the present disclosure advantageously provide methods and systems for controlling a light engine of an illumination system that eliminates the LUT, significantly reduces non-volatile memory storage requirements, accesses the color palette and intensity regime that that may be generated by the light engine, and generates an output light beam whose intensity has a linear relationship with the desired intensity.

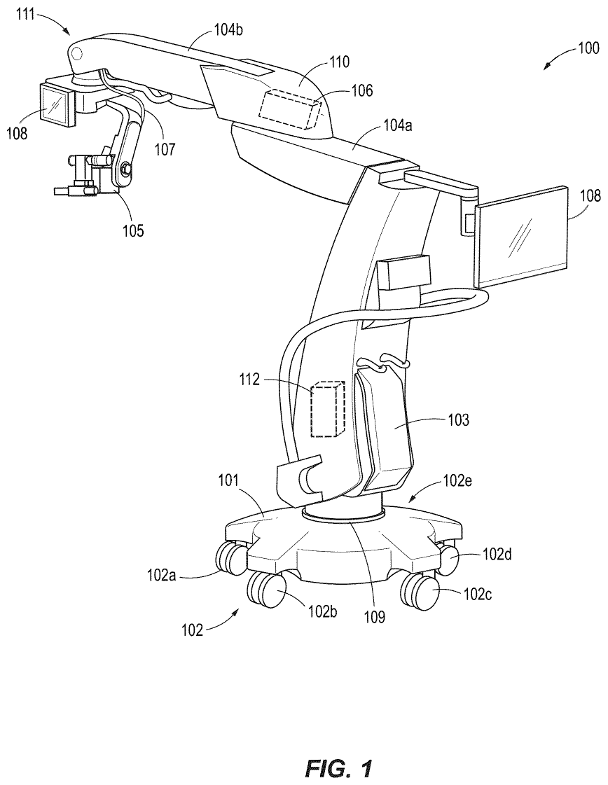

FIG. 1 depicts a perspective view of an ophthalmic microscope system 100, in accordance with embodiments of the present disclosure.

In certain embodiments, the ophthalmic microscope system 100 may include a floor stand 101, a base 103, a first arm 104a, a second arm 104b, an optical head 105, an illumination system 106, one or more fiber optic cables 107 that extend from the illumination system 106 to the optical head 105, one or more displays 108, and a control system 112.

The floor stand 101 may include three or more wheels 102, such as wheels 102a, 102b, 102c, 102d, and 102e (not visible) arranged in a star pattern. The wheels 102 may be lockable to prevent movement of the floor stand 101.

The base 103 is coupled to the floor stand 101 using a rotational coupling 109, which may provide a single, rotational degree-of-freedom (DOF). In some other embodiments, the ophthalmic microscope system 100 may be mounted to a table, a wall, the floor, etc., and the floor stand 101 may be replaced by a mount or mounting system that is coupled to the base 103. For example, the ophthalmic microscope system 100 may be mounted to a table using a table stand that is securely attached to the table.

The first arm 104a is attached to the base 103, and is coupled to the second arm 104b using a joint assembly 110, which may provide one or more DOFs. The second arm 104b is coupled to the optical head 105 through a joint assembly 111, which may provide one or more DOFs. The optical head 105 may include, inter alia, the ophthalmic microscope, the endpoints of the fiber optic cables 107 for the illumination system 106, etc., as well as one or more joints, couplings, etc., that provide one or more additional DOFs. Due to the DOFS provided by the optical head 105, the rotational coupling 109, the joint assembly 110, and the joint assembly 111, the optical head 105 may be moved to various positions and orientations with respect to the head of a patient, such as a position located above an eye of the patient.

The illumination system 106 may be co-located with, or spaced apart from, the optical head 105. For example, the illumination system 106 may be located on or within the base 103, the first arm 104a, the second arm 104b, etc. In certain embodiments, the illumination system 106 may be located within the joint assembly 110 (depicted in dotted line). Similarly, the control system 112 may be co-located with, or spaced apart from, the ophthalmic microscope system 100, such as within the base 103 (depicted in dotted line), etc.

The ophthalmic microscope system 100 may include a display 108 mounted to the top of the base 103, and a display 108 mounted to the top of the optical head 105. Other mounting locations are also supported. The display 108 may be a liquid crystal display (LCD), a plasma display, an LED display, etc., and includes a touchscreen for accepting user input (also known as a touchscreen display, a touchscreen monitor, etc.). The display 108 may present a user interface that includes images generated by the ophthalmic microscope in the optical head 105, information relating to the operation and control of the illumination system 106, etc.

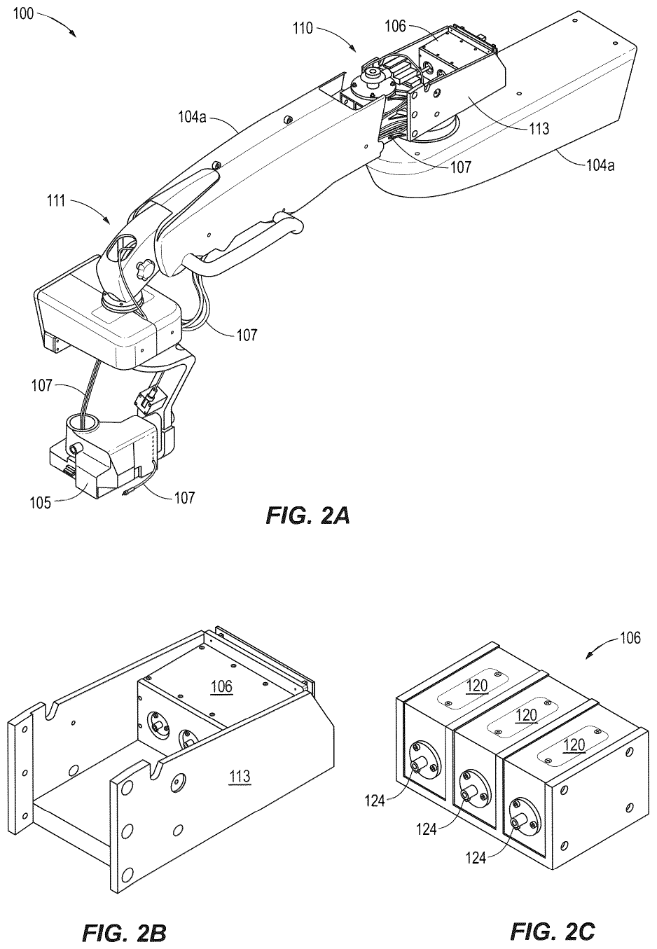

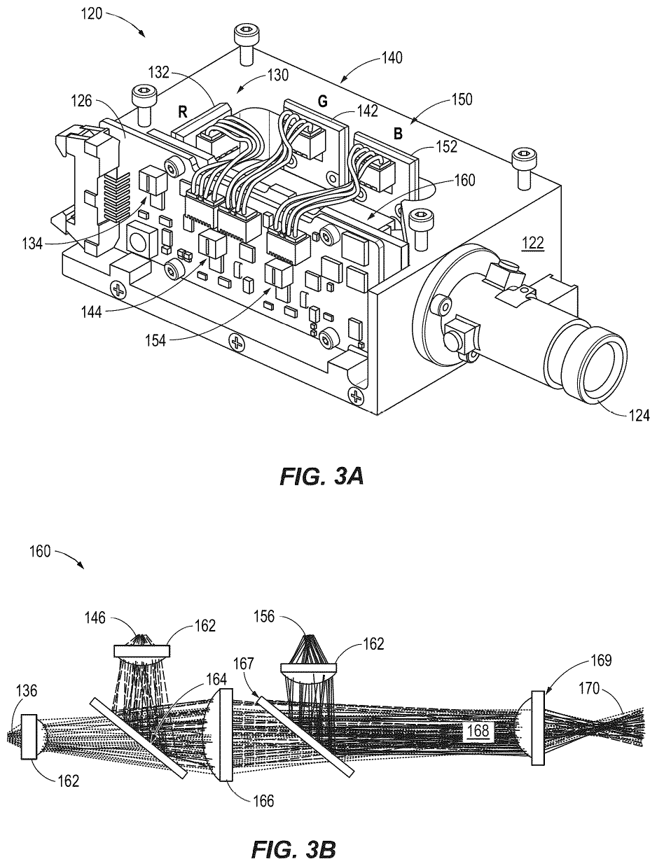

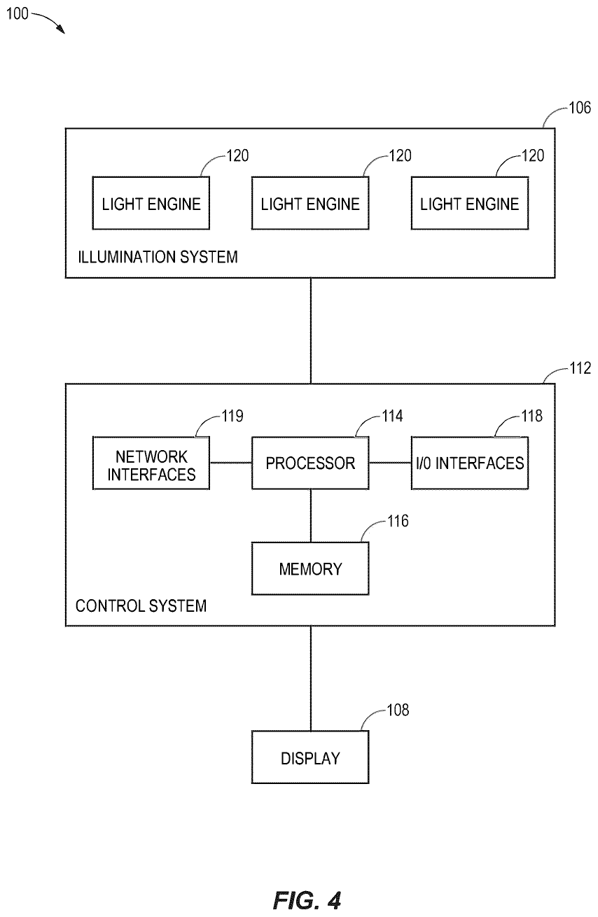

FIG. 2A depicts a perspective view of the arms 104a, 104b, the joint assemblies 110, 111, and the optical head 105 of the ophthalmic microscope system 100, FIG. 2B depicts a perspective view of a support frame 113, and FIG. 2C depicts a perspective view of an illumination system 106, in accordance with embodiments of the present disclosure.

The first arm 104a, the joint assembly 110, the second arm 104b, the joint assembly 111, the optical head 105, the illumination system 106, and the fiber optic cables 107 are illustrated. The joint assembly 110 includes a support frame 113 in which the illumination system 106 is mounted. Generally, the illumination system 106 may include one or more light engines 120. In certain embodiments, the illumination system 106 may include three (3) light engines 120, and each light engine 120 may include an optical coupling 124 for one of the fiber optic cables 107, such as an SMA connector, etc.

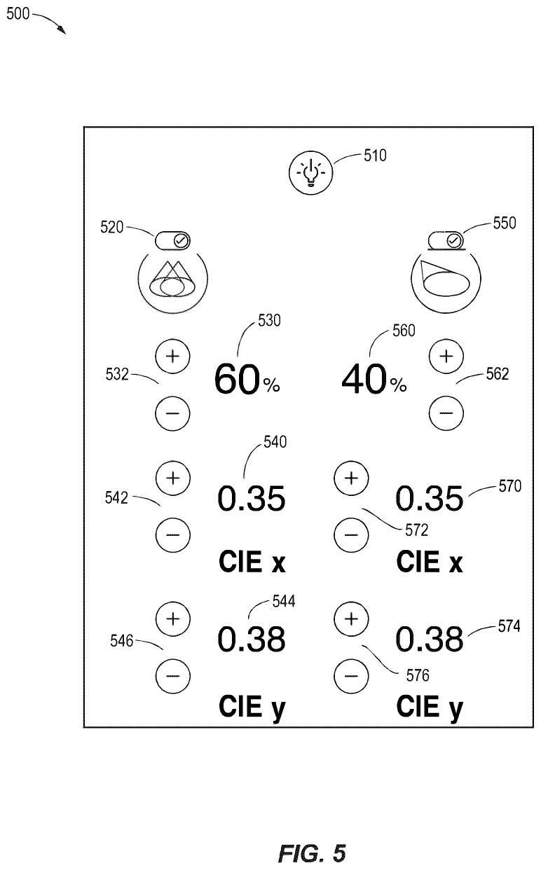

FIG. 3A depicts a perspective, cut away view of a light engine 120, and FIG. 3B depicts a diagram of an optical system 160 of the light engine 120, in accordance with embodiments of the present disclosure.

In certain embodiments, the light engine 120 includes, inter alia, a housing 122, an optical coupling 124, an LED drive circuit board 126, a red LED 130, a green LED 140, a blue LED 150, and an optical system 160.

Generally, each LED includes an LED module and a drive circuit. The LED module may also be known as an LED lamp module, an LED chip module, etc. More particularly, the red LED 130 includes a red LED module 132 and a drive circuit 134, the green LED 140 includes a green LED module 142 and a drive circuit 144, and the blue LED 150 includes a blue LED module 152 and a drive circuit 154. The drive circuits 134, 144, 154 may be mounted on the LED drive circuit board 126, as depicted in FIG. 3A.

The optical system 160 combines the red LED light beam 136, the green LED light beam 146, and the blue LED light beam 156 to generate an output light beam 170 that is transmitted via an fiber optic cable 107 to the optical element within the optical head 105. The optical element receives the light transmitted by the fiber optic cable 107, and projects the light onto a viewing area of the eye of a patient, such as the cornea, the iris, the pupil, the lens, the ciliary muscle, or other regions of the eye.

In certain embodiments, the optical system 160 may include, inter alia, a collimator lens 162 for the red LED light beam 136, a collimator lens 162 for the green LED light beam 146, a collimator lens 162 for the blue LED light beam 156, a first dichroic beam combiner 164, a transition lens 166, a second dichroic beam combiner 167, and a condenser lens 169. The first dichroic beam combiner 164 combines the red LED light beam 136 and the green LED light beam 146 into a red/green light beam 165, which is passed through the transition lens 166. The second dichroic beam combiner 167 combines red/green light beam 165 and the blue LED light beam 156 into a red/green/blue light beam 168, which is passed through the condenser lens 169 and provided as the output light beam 170 from the light engine 120.

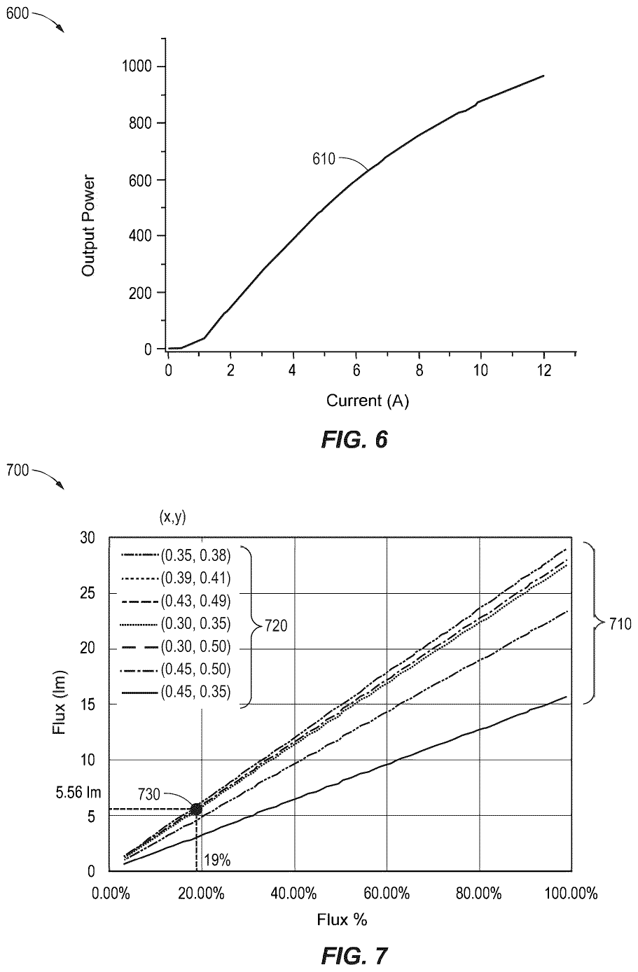

FIG. 4 presents a block diagram of the control system 112 and the illumination system 106 of the ophthalmic microscope system 100, in accordance with embodiments of the present disclosure.

In certain embodiments, the control system 112 may include, inter alia, a processor 114 coupled to a memory 116, I/O interfaces 118, and network interfaces 119. The control system 112 is coupled to the illumination system 106, and to one or more displays 108. The control system may also be coupled to one or more I/O devices (such as a keyboard, mouse, trackpad, etc.), and to one or more wired or wireless networks using Ethernet, WiFi, Bluetooth, etc., such as a local area network (LAN), a wide area network (WAN), etc.

Generally, the memory 116 may include volatile and non-volatile memory, and may store instructions that are executable by the processor 114. The instructions, when executed by the processor 114, cause the processor 114 to perform various functions, such as presenting a user interface on the display 108, receiving user input from the display 108 (or an I/O device), determining power commands for each LED within a light engine 120 to generate a desired color and a desired total flux output from the light engine 120, etc. For example, the power command for each LED may be a pulse-width-modulation (PWM) signal that is sent to the drive circuit of the LED. The PWM signal causes the drive circuit to output a drive current to the LED.

In certain embodiments, the illumination system 106 may include three light engines 120. The optical elements for two light engines 120 may be arranged in the optical head 105 to provide two coaxial light beams to illuminate the patient's eye at an angle that is parallel to the optical axis of the ophthalmic microscope. The optical element of the third light engine 120 may be arranged in the optical head 105 to provide a single oblique light beam to illuminate the patient's eye at an oblique angle to the optical axis of the ophthalmic microscope.

Other arrangements of light engines are also supported. For example, the illumination system 106 may include one light engine 120, and the optical element may be arranged in the optical head 105 to provide a single coaxial light beam. In a further example, the illumination system 106 may include two light engines 120. In one arrangement, the optical elements for both light engines 120 may be arranged in the optical head 105 to provide two coaxial light beams. In another arrangement, the optical element for one light engine 120 may be arranged in the optical head 105 to provide a single coaxial light beam, and the optical element for the other light engine 120 may be arranged in the optical head 105 to provide a single oblique light beam.

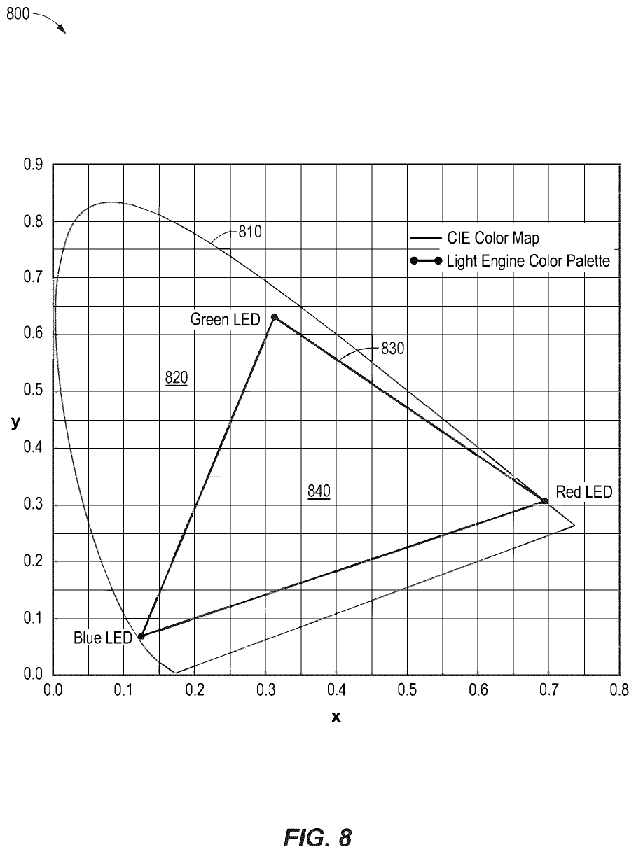

FIG. 5 depicts a user interface 500 for the ophthalmic microscope system 100, in accordance with embodiments of the present disclosure.

The user interface 500 may be presented on the display 108 of the ophthalmic microscope system 100, and may include, inter alia, information relating to the operation and control of the illumination system 106. Generally, the user interface 500 may include graphical display and control elements or widgets, such as switches, buttons, icons, numerical displays, etc., which allow the user (such as an ophthalmic surgeon, a surgical nurse, etc.) to review and adjust the operating parameters of the illumination system 106.

The example embodiment of the user interface 500 depicted in FIG. 5 supports the operation and control of an illumination system 106 that includes three light engines 120 that provide two coaxial light beams and one oblique light beam to illuminate the patient's eye. The light engines 120 that provide the coaxial light beams may be commonly controlled using a one set of input parameters (as depicted). Alternatively, the light engines 120 that provide the coaxial light beams may be independently controlled using two sets of input parameters.

The user interface 500 may include, inter alia, a power status icon 510, a coaxial power switch 520, and an oblique power switch 550. The power status icon 510 provides an overall power status indication for the illumination system 106, such as “on” (as depicted) or “off. The coaxial power switch 520 controls the power to the light engines 120 that provide the coaxial light beams, such as “on” (as depicted) or “off.” Similarly, the oblique power switch 550 controls the power to the light engine 120 that provides the oblique light beam, such as “on” (as depicted) or “off.”

The user interface 500 may also include, inter alia, coaxial light beam color and intensity (or flux) controls that provide the input parameters to the respective light engines 120, and oblique light beam color flux and controls that provide the input parameters to the respective light engine 120.

More particularly, the coaxial light beam flux controls may include a desired total flux output display 530 and associated increment/decrement buttons 532. The increment/decrement buttons 532 change the desired total flux output from a minimum flux value to a maximum flux value in predetermined increments, such as 0% to 100% in 1% increments, etc. The coaxial light beam color controls may include a desired CIE x chromaticity display 540 and associated increment/decrement buttons 542, and a desired CIE y chromaticity display 544 and associated increment/decrement buttons 546. The increment/decrement buttons 542 change the desired CIE x chromaticity from a minimum chromaticity value to a maximum chromaticity value in predetermined increments, such as 0.12 to 0.70 in 0.01 increments, etc. The increment/decrement buttons 546 change the desired CIE y chromaticity from a minimum chromaticity value to a maximum chromaticity value in predetermined increments, such as 0.06 to 0.65 in 0.01 increments, etc.

Similarly, the oblique light beam flux controls may include a desired total flux output display 560 and associated increment/decrement buttons 562. The increment/decrement buttons 562 change the desired total flux output from a minimum flux value to a maximum flux value in predetermined increments, such as 0% to 100% in 1% increments, etc. The oblique light beam color controls may include a desired CIE x chromaticity display 570 and associated increment/decrement buttons 572, and a desired CIE y chromaticity display 574 and associated increment/decrement buttons 576. The increment/decrement buttons 572 change the desired CIE x chromaticity from a minimum chromaticity value to a maximum chromaticity value in predetermined increments, such as 0.12 to 0.70 in 0.01 increments, etc. The increment/decrement buttons 576 change the desired CIE y chromaticity from a minimum chromaticity value to a maximum chromaticity value in predetermined increments, such as 0.06 to 0.65 in 0.01 increments, etc.

As discussed above, the intensity of an LED light beam is a nonlinear function of the current output by the drive circuit of the LED. This nonlinearity previously caused the color and intensity of the output light beam of a light engine to be nonlinear as well, which prevented precise control of the output light beam with respect to the desired color and intensity.

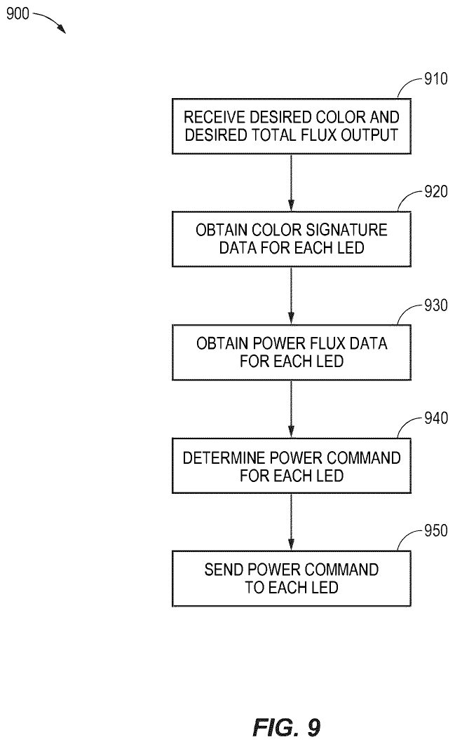

FIG. 6 depicts a graph 600 presenting LED output brightness nonlinearity, in accordance with embodiments of the present disclosure.

The graph 600 presents LED drive circuit output current (in amps or A) along the X axis, and LED output power (in milliwatts or mW) along the Y axis. The LED output brightness curve 610 demonstrates that LED output power is a nonlinear function of LED drive circuit output current. In other words, because the relationship between LED drive circuit output current and LED output power is not linear (i.e., not constant), the intensity of the output light beam of a light engine does not have a linear relationship with the desired intensity.

Advantageously, embodiments of the present disclosure compensate for this nonlinearity by generating a light engine output light beam whose intensity has a linear relationship with the desired intensity.

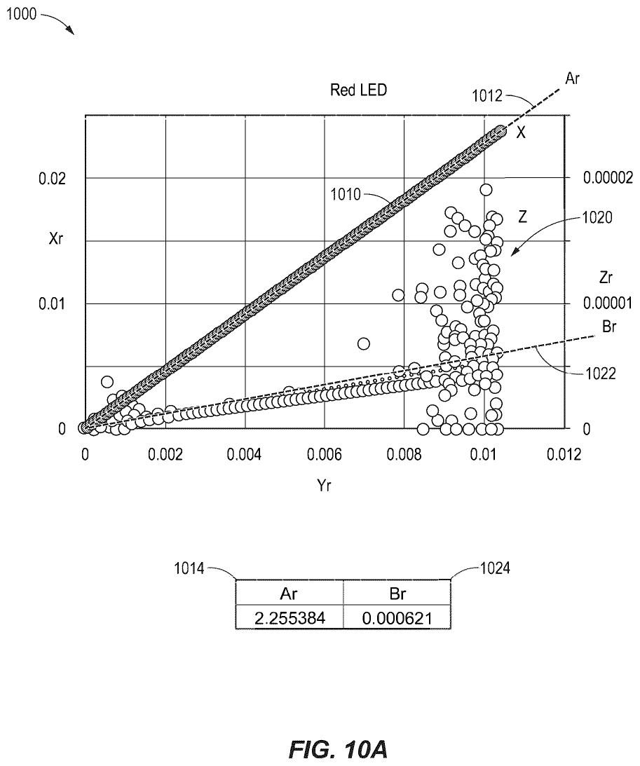

FIG. 7 depicts a graph 700 presenting light engine output brightness linearity, in accordance with embodiments of the present disclosure.

The graph 700 presents light engine output brightness (in % desired total flux output) along the X axis, and light engine output brightness (in lumens or lm) along the Y axis. Light engine output brightness curves 710 for 7 different colors are presented, and are identified by pairs of CIE x and y chromaticity values 720, such as 0.35 and 0.38, etc. The light engine output brightness curves 710 demonstrate that light engine output power is a linear function of the desired total flux output. In other words, the relationship between the desired total flux output and the output flux is linear (i.e., constant). Operating point 730 has a desired CIE x chromaticity value of 0.35, a desired CIE y value of 0.38, a desired total output flux of 19%, and an actual flux of 5.56 lumens, and will be described below.

Additionally, embodiments of the present disclosure advantageously access the entire color palette and intensity regime that may be generated by the light engine.

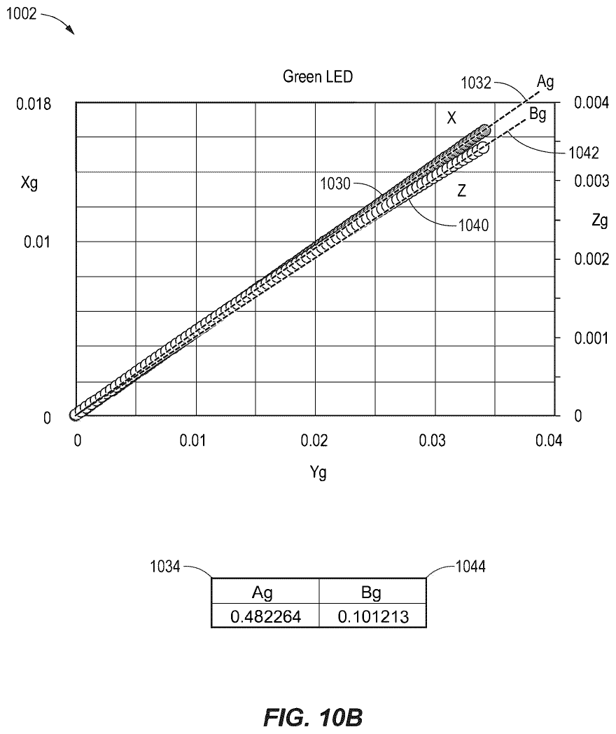

FIG. 8 depicts a graph 800 presenting a CIE 1931 color map 820 and a light engine color palette region 840, in accordance with embodiments of the present disclosure.

The graph 800 presents CIE x chromaticity along the X axis, and CIE y chromaticity along the Y axis. The CIE 1931 color map border 810 defines the boundary of the CIE 1931 color map 820. Generally, the CIE x chromaticity is a real number that has a range between about 0.0 and 1.0, and the CIE y chromaticity is a real number that has a range between about 0.0 and 1.0. In certain embodiments, the precision of the CIE x chromaticity and CIE y chromaticity numeric values that define the desired color may be 2 or more digits, such as “35” in the CIE x chromaticity value “0.35” depicted in the CIE x chromaticity display 540 of FIG. 5.

The light engine color palette border 830 defines the light engine color palette region 840 from which the desired color of the light engine output light beam may be selected by the user. The red LED module 132 emits a color that is in the far right portion of the light engine color palette region 840. The green LED module 142 emits a color that is in the upper central portion of the light engine color palette region 840. The blue LED module 152 emits a color that is in the lower left portion of the light engine color palette region 840.

Embodiments of the present disclosure advantageously provide a method of controlling a light engine 120 of an illumination system 106 that, inter alia, determines and sends a power command to each LED in the light engine 120 to generate a desired color and a desired total flux output from the light engine 120.

For convenience, aspects of the present disclosure will be discussed with respect to a light engine 120 that has an optical element arranged on the optical head 105 to provide an oblique light beam to illuminate the patient's eye at an oblique angle to the optical axis of the ophthalmic microscope.

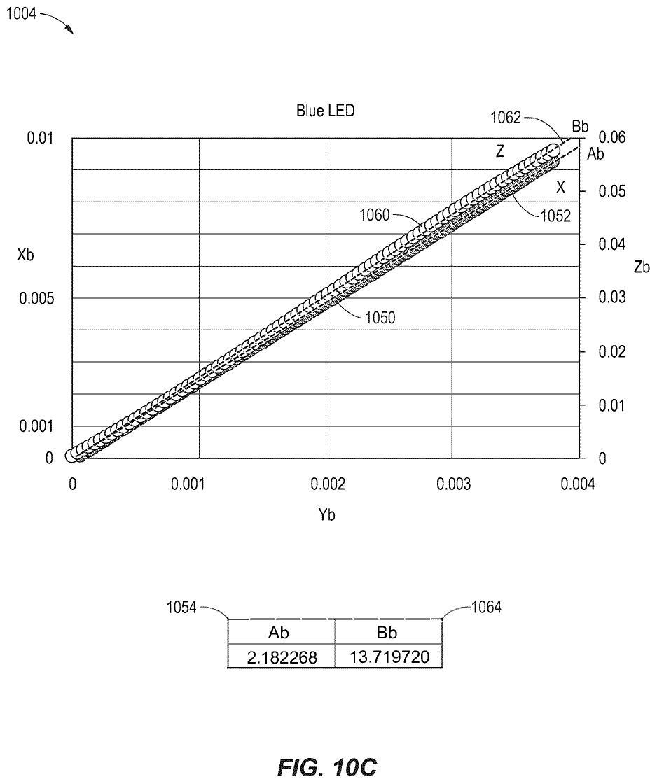

FIG. 9 depicts a flow diagram 900 presenting functionality associated with controlling a light engine 120 of the illumination system 106, in accordance with embodiments of the present disclosure.

At 910, the processor 114 receives a desired color and a desired total flux output of a light engine from a user input device.

Initially, the processor 114 may present the user interface 500 to the user on the display 108. The user may set the oblique power switch 550 to turn on the light engine 120, and then set the desired color and the desired total flux output. As described above, the desired color may be set by incrementing or decrementing the increment/decrement buttons 572 to change the CIE x chromaticity until the desired value is displayed in the desired CIE x chromaticity display 570, and incrementing or decrementing the increment/decrement buttons 576 to change the CIE y chromaticity until the desired value is displayed in the desired CIE y chromaticity display 574.

Similarly, the desired total flux output may be set by incrementing or decrementing the increment/decrement buttons 562 to change the total flux output until the desired value is displayed in the desired total flux output display 560. In certain embodiments, the desired total flux output may be a positive integer between a minimum flux value and a maximum flux value, such as 0 and 100, 10 and 90, etc. For example, the desired total flux output may be a percentage between 0% and 100%, which is adjustable in 1% increments. Generally, the desired total flux output may be any value representing relative level or absolute intensity or flux.

At 920, the processor 114 obtains color signature data for each LED of the light engine 120, such as the red LED 130, the green LED 140, and the blue LED 150.

In certain embodiments, the color signature data for each LED includes two color signature values, A and B. The color signature values A and B of each LED may be determined during manufacturing, bench testing, performance testing, etc., of the LEDs or the light engine 120, and then stored in memory 116. More particularly, the red LED 130 may have color signature values Aᵣ and Bᵣ, the green LED 140 may have color signature values A_{g} and B_{g}, and the blue LED 150 may have color signature values A_{b} and B_{b}. Accordingly, during operation of the illumination system 106, the processor 114 may retrieve the color signature values for each LED from memory 116, such as Aᵣ and Bᵣ, A_{g} and B_{g}, and A_{b} and B_{b}.

The color signature values A and B are determined for each LED by measuring the output flux and the CIE X, Y, and Z characteristics of the LED's output light beam as the drive current is changed from a minimum value to a maximum value (such as 0.01% to 99% of the maximum drive current). The CIE 1931 XYZ color space defines CIE Y as luminance, and CIE X and Z as chromaticity.

To determine the color signature value A, a linear fit is applied to the measured CIE X data and the measured CIE Y data, a slope of the linear “fitting” line is determined, and the color signature value A is set to the slope. To determine the color signature value B, a linear fit is applied to the measured CIE X data and the measured CIE Z data, a slope of the linear fitting line is determined, and the color signature value B is set to the slope.

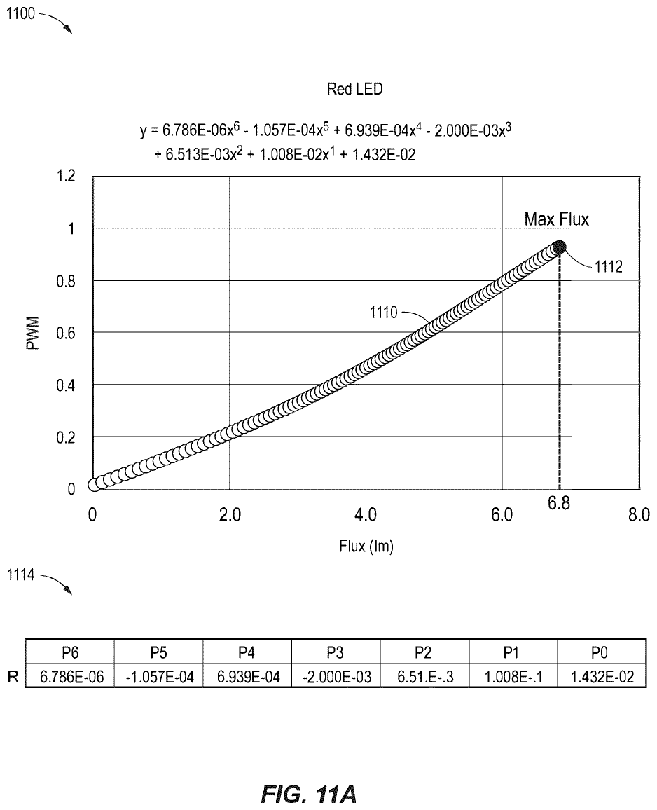

FIGS. 10A, 10B, 10C present measured CIE X, Y, and Z data and color signature values for a red LED, a green LED, and a blue LED, respectively, in accordance with embodiments of the present disclosure.

Referring to FIG. 10A, graph 1000 presents CIE Y along the X axis, CIE X along the left Y axis, and CIE Z along the right Y axis. Measured CIE Yᵣ data versus CIE Xᵣ data 1010, the linear fitting line 1012, measured CIE Yᵣ data versus CIE Zᵣ data 1020, and the linear fitting line 1022 are depicted. The color signature value Aᵣ 1014 is the slope of the linear fitting line 1012, while the color signature value Bᵣ 1024 is the slope of the linear fitting line 1022.

Referring to FIG. 10B, graph 1002 presents CIE Y along the X axis, CIE X along the left Y axis, and CIE Z along the right Y axis. Measured CIE Y_{g} data versus CIE X_{g} data 1030, the linear fitting line 1032, measured CIE Y_{g} data versus CIE Z_{g} data 1040, and the linear fitting line 1042 are depicted. The color signature value A_{g} 1034 is the slope of the linear fitting line 1032, while the color signature value B_{g} 1044 is the slope of the linear fitting line 1042.

Referring to FIG. 10C, graph 1004 presents CIE Y along the X axis, CIE X along the left Y axis, and CIE Z along the right Y axis. Measured CIE Y_{b} data versus CIE X_{b} data 1050, the linear fitting line 1052, measured CIE Y_{b} data versus CIE Z_{b} data 1060, and the linear fitting line 1062 are depicted. The color signature value A_{b} 1054 is the slope of the linear fitting line 1052, while the color signature value B_{b} 1064 is the slope of the linear fitting line 1062.

Referring back to FIG. 9, at 930, the processor 114 obtains power flux data for each LED of the light engine 120, such as the red LED 130, the green LED 140, and the blue LED 150.

In certain embodiments, an n^{th} order polynomial may be used to describe the relationship between the PWM signal provided to the drive circuit of each LED and the output flux from each LED. The power flux data for each LED may include the parameter values for the n^{th} order polynomial, which may be determined based on a polynomial fit to measured LED output flux data versus PWM signal data provided to the LED drive circuit.

The polynomial parameters for each LED are different, and may be determined during manufacturing, bench testing, performance testing, etc., of the LEDs or the light engine 120, and then stored in memory 116. More particularly, the red LED 130 may have polynomial parameters Pr₀, Pr₁, . . . , Prₙ, the green LED 140 may have polynomial parameters Pg₀, Pg₁, . . . , Pgₙ, and the blue LED 150 may have polynomial parameters Pb₀, Pb₁, . . . , Pbₙ. Accordingly, during operation of the illumination system 106, the processor 114 may retrieve the polynomial parameters values P₀, P₁, . . . , Pₙ for each LED from memory 116.

To determine the polynomial parameters P₀, P₁, . . . , Pₙ for each LED, a polynomial fit is applied to measured LED output flux data and PWM signal data, and the polynomial parameters P₀, P₁, . . . , Pₙ are provided by the polynomial fit. In certain embodiments, a 6^{th} order polynomial may be used to describe the relationship between the PWM signal provided to the drive circuit of each LED (PWM) and the output flux from each LED (Flux). The polynomial parameters for a 6^{th} order polynomial include P₀, P₁, P₂, P₃, P₄, P₅, P₆, and the polynomial equation is given by Equation 1:

$$PWM = {P}_{6} \cdot {( Flux )}^{6} + {P}_{5} \cdot {( Flux )}^{5} + {P}_{4} \cdot {( Flux )}^{4} + {P}_{3} \cdot {( Flux )}^{3} \cdot {P}_{2} \cdot {( Flux )}^{2} + {P}_{1} \cdot {( Flux )}^{1} + {P}_{0} \qquad Eq . 1$$

Other n^{th} order polynomials are also supported, such as a 3^{rd} order polynomial, a 4^{th} order polynomial, a 7^{th} order polynomial, etc.

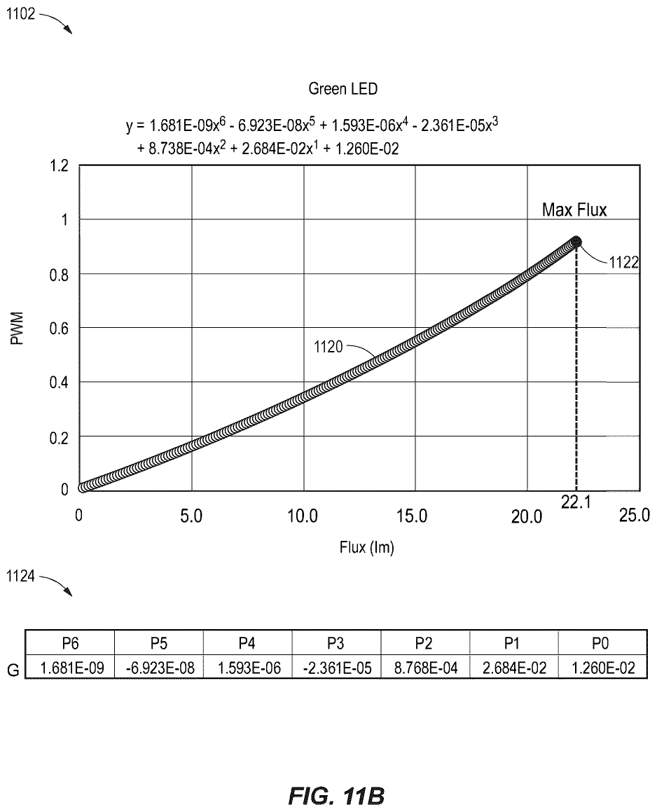

FIGS. 11A, 11B, 11C present measured LED output flux data and PWM signal data for a red LED, a green LED, and a blue LED, respectively, in accordance with embodiments of the present disclosure.

Referring to FIG. 11A, graph 1100 depicts measured output flux data for a red LED, and presents output flux along the X axis and PWM signal along the Y axis. Measured output flux data 1110, a maximum flux 1112, and the polynomial parameters 1114 are depicted.

Referring to FIG. 11B, graph 1102 depicts measured output flux data for a green LED, and presents output flux along the X axis and PWM signal along the Y axis. Measured output flux data 1120, a maximum flux 1122, and the polynomial parameters 1124 are depicted.

Referring to FIG. 11C, graph 1104 depicts measured output flux data for a blue LED, and presents output flux along the X axis and PWM signal along the Y axis. Measured output flux data 1130, a maximum flux 1132, and the polynomial parameters 1134 are depicted.

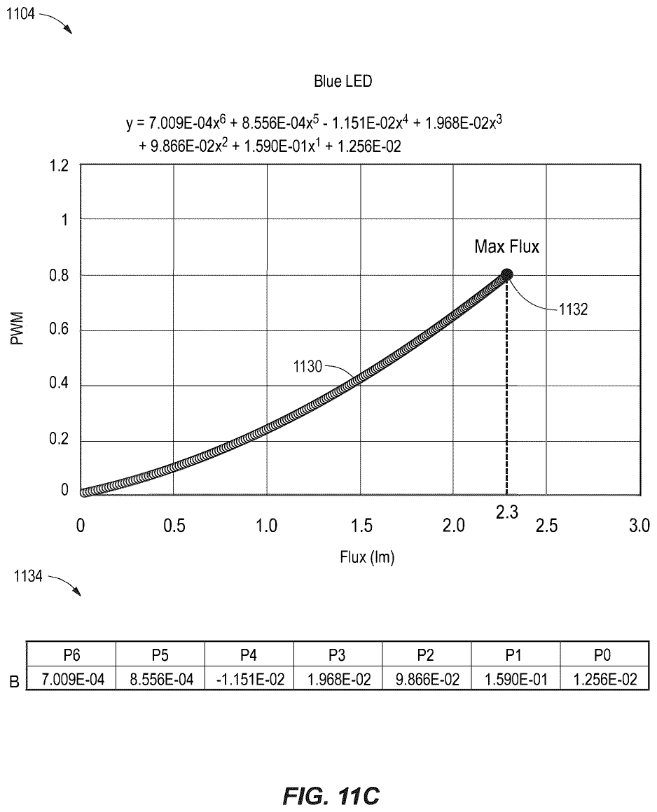

For convenience, FIG. 12 presents the color signature values 1200 and the polynomial parameters 1210 for the red, green, and blue LEDs described in FIGS. 10A, 10B, 10C, 11A, 11B, and 11C.

Referring back to FIG. 9, at 940, the processor 114 determines a power command for each LED based on the color signature data for each LED, the power flux data for each LED, the desired color, and the desired total flux output.

In certain embodiments, the processor 114 first determines a maximum flux value (Fc-max) for the desired color identified by the CIE x and CIE y chromaticity values set by the user (as described in more detail below).

The processor 114 then determines a baseline flux (Y₀) that is based on Fc-max and the desired total flux output (Y %) set by the user, as given by Equation 2:

$${Y}_{0} = Y \% \cdot Fc - max \qquad Eq . 2$$

The processor 114 then determines CIE X, Y, and Z values based on Y₀, the desired color identified by the CIE x and CIE y chromaticity values set by the user, and a conversion constant (i.e., 683), as given by Equations 3, 4, and 5:

$$Y = {Y}_{0} / 683 \qquad Eq . 3$$

$$X = ( x / y ) \cdot Y \qquad Eq . 4$$

$$Z = ( ( 1 - x - y ) / y ) \cdot Y \qquad Eq . 5$$

The processor 114 then determines the CIE Y values for the red, green, and blue LEDs (Yᵣ Y_{g}, Y_{b}) based on the color signature data for each LED (Aᵣ, Bᵣ, A_{g}, B_{g}, A_{b}, B_{b}), the CIE X, Y and Z values determined by Equations 3, 4, and 5, and the matrices D, Dᵣ, D_{g}, and D_{b}, as given by Equations 6, 7, and 8:

$${Y}_{r} = {D}_{r} / D \qquad Eq . 6$$

$${Y}_{g} = {D}_{g} / D \qquad Eq . 7$$

$${Y}_{b} = {D}_{b} / D \qquad Eq . 8$$

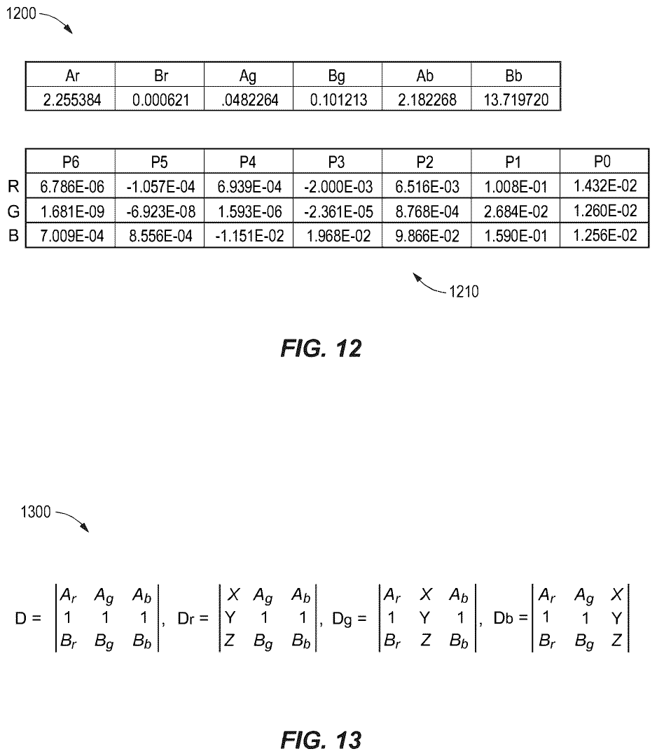

FIG. 13 presents example matrices D, Dᵣ, D_{g}, and D_{b}, in accordance with embodiments of the present disclosure.

The processor 114 then determines the output flux for each LED (Fᵣ, F_{g}, F_{b}) based on Yᵣ, Y_{g}, Y_{b} and the conversion constant (i.e., 683), as given by Equations 9, 10, and 11:

$${F}_{r} = {Y}_{r} \cdot 683 \qquad Eq . 9$$

$${F}_{g} = {Y}_{g} \cdot 683 \qquad Eq . 10$$

$${F}_{b} = {Y}_{b} \cdot 683 \qquad Eq . 11$$

The processor 114 then determines the power command for each LED (PCᵣ, PC_{g}, PC_{b}) as a PWM duty cycle percentage (between 0% and 100%) based on Fᵣ, F_{g}, F_{b} and the polynomial parameters for each LED (Pr₀, Pr₁, Pr₂, Pr₃, Pr₄, Pr₅, Pr₆; Pg₀, Pg₁, Pg₂, Pg₃, Pg₄, Pg₅, Pg₆; Pb₀, Pb₁, Pb₂, Pb₃, Pb₄, Pb₅, Pb₆), as given by Equations 12, 13, and 14:

$${PC}_{r} = {Pr}_{6} \cdot {( {F}_{r} )}^{6} + {Pr}_{5} \cdot {( {F}_{r} )}^{5} + {Pr}_{4} \cdot {( {F}_{r} )}^{4} + {Pr}_{3} \cdot {( {F}_{r} )}^{3} + {Pr}_{2} \cdot {( {F}_{r} )}^{2} + {Pr}_{1} \cdot {( {F}_{r} )}^{1} + {Pr}_{0} \qquad Eq . 12$$

$${PC}_{g} = {Pg}_{6} \cdot {( {F}_{g} )}^{6} + {Pg}_{5} \cdot {( {F}_{g} )}^{5} + {Pg}_{4} \cdot {( {F}_{g} )}^{4} + {Pg}_{3} \cdot {( {F}_{g} )}^{3} + {Pg}_{2} \cdot {( {F}_{g} )}^{2} + {Pg}_{1} \cdot {( {F}_{g} )}^{1} + {Pg}_{0} \qquad Eq . 13$$

$${PC}_{b} = {Pb}_{6} \cdot {( {F}_{b} )}^{6} + {Pb}_{5} \cdot {( {F}_{b} )}^{5} + {Pb}_{4} \cdot {( {F}_{b} )}^{4} + {Pb}_{3} \cdot {( {F}_{b} )}^{3} + {Pb}_{2} \cdot {( {F}_{b} )}^{2} + {Pb}_{1} \cdot {( {F}_{b} )}^{1} + {Pb}_{0} \qquad Eq . 14$$

To determine the maximum flux value (Fc-max) for the desired color identified by the CIE x and CIE y chromaticity values set by the user, the processor 114 sets Y₀ to 1 in Equation 2, and then follows the process described above with respect to Equations 3 to 11 to determine the output flux for each LED (F′ᵣ, F′_{g}, F′_{b}).

The processor 114 then determines a flux triplet ratio (F^{T}ᵣ, F^{T}_{g}, F^{T}_{b}) for the desired color, as given by Equations 15, 16, and 17:

$${F}_{r}^{T} = {F}_{r}^{′} / {F}_{g}^{′} \qquad Eq . 15$$

$${F}_{g}^{T} = {F}_{g}^{′} / {F}_{g}^{′} = 1 \qquad Eq . 16$$

$${F}_{b}^{T} = {F}_{b}^{′} / {F}_{g}^{′} \qquad Eq . 17$$

The processor 114 then determines a maximum flux triplet (Fc-maxᵣ, Fc-max_{g}, Fc-max_{b}) for the desired color by setting Fc-max_{g} to Fg-max (such as the maximum flux 1122 depicted in FIG. 11B), and then determining Fc-maxᵣ and Fc-max_{b} based on Fg-max, F^{T}ᵣ, and F^{T}_{b}, as given by Equations 18 and 19:

$$Fc - {max}_{r} = {F}_{r}^{T} \cdot Fg - max \qquad Eq . 18$$

$$Fc - {max}_{b} = {F}_{b}^{T} \cdot Fg - max \qquad Eq . 19$$

The processor 114 may then determine Fc-max as given by Equation 20:

$$Fc - max = Fc - {max}_{r} + Fc - {max}_{g} + Fc - {max}_{b} \qquad Eq . 20$$

In certain embodiments, the processor 114 may determine Fc-max based on a set of conditions. In addition to Fg-max described above, Fr-max (such as the maximum flux 1112 depicted in FIG. 11A) and Fb-max (such as the maximum flux 1132 depicted in FIG. 11C) may also be used.

For a first condition, if Fc-maxᵣ<Fr-max and Fc-max_{b}<Fb-max, then Fc-max is determined using Equation 20.

For a second condition, if Fc-maxᵣ>Fr-max and Fc-max_{b}<Fb-max, then let Fc-maxᵣ=Fr-max, Fc-max_{g}=Fc-maxᵣ/F^{T}r, and Fc-max_{b}=F^{T}b*Fc-max_{g}, and Fc-max is determined using Equation 20.

For a third condition, if Fc-maxᵣ<Fr-max and Fc-max_{b}>Fb-max, then let Fc-max_{b}=Fb-max, Fc-max_{g}=Fc-max_{b}/F^{T}b, Fc-maxᵣ=F^{T}r*Fc-max_{g}, and Fc-max is determined using Equation 20.

For a fourth condition, if Fc-maxᵣ>Fr-max and Fc-max_{b}>Fb-max, then let Fc-maxᵣ=Fr-max, Fc-max_{g}=Fc-maxᵣ/F^{T}r, Fc-max_{b}=F^{T}b*Fc-max_{g}, and Fc-max is determined using the following two sub-conditions. For a first sub-condition, if Fc-max_{b}<Fb-max and Fc-max is determined using Equation 20. For a second sub-condition, if Fc-max_{b}>Fb-max, then let Fc-max_{b}=Fb-max, Fc-max_{g}=Fc-max_{b}/F^{T}b, Fc-maxᵣ=F^{T}r*Fc-max_{g} and Fc-max is determined using Equation 20.

Referring back to FIG. 9, at 950, the processor 114 sends each power command to the LED to generate the desired color and the desired total flux output from the light engine 120, such as red LED 130, green LED 140, and blue LED 150.

The many features and advantages of the disclosure are apparent from the detailed specification, and, thus, it is intended by the appended claims to cover all such features and advantages of the disclosure which fall within the scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. A method of controlling a light engine of an illumination system, comprising:
receiving, from a user input device, a desired color and a desired total flux output of a light engine comprising two or more light emitting diodes (LEDs);
obtaining color signature data for each LED of the light engine;
obtaining power flux data for each LED of the light engine;
determining a power command for each LED based on the color signature data for each LED, the power flux data for each LED, the desired color, and the desired total flux output; and
sending each power command to the LED to generate the desired color and the desired total flux output from the light engine.

2. The method of claim 1, wherein the light engine comprises a red LED, a green LED, and a blue LED.

3. The method of claim 2, wherein the desired color comprises a Commission Internationale de l'éclairage (CIE) x value and a CIE y value.

4. The method of claim 3, wherein the color signature data comprise a first color signature value and a second color signature value.

5. The method of claim 4, wherein:
the first color signature value comprises a first slope of a linear fit to measured CIE X data versus measured CIE Y data; and
the second color signature value comprises a second slope of a linear fit to measured CIE Z data versus measured CIE Y data.

6. The method of claim 5, wherein the measured CIE Y data define a luminance, and the measured CIE X data and the measured CIE Z data define a chromaticity.

7. The method of claim 2, wherein:
each LED of the light engine comprises an LED module coupled to an LED drive circuit; and
the power command for each LED is a pulse-width modulation (PWM) signal that causes the LED drive circuit to output a drive current to the LED module.

8. The method of claim 7, wherein the desired total flux output comprises a value between a minimum flux value and a maximum flux value.

9. The method of claim 8, wherein the desired total flux output is a positive integer value between 0 and 100, and the positive integer value represents a percentage between 0% and 100%.

10. The method of claim 7, wherein the power flux data comprise polynomial parameter values that are determined based on a polynomial fit to PWM signal data provided to the LED drive circuit versus measured LED output flux data.

11. The method of claim 10, wherein the polynomial parameter values include scalar coefficients for a polynomial having a degree.

12. The method of claim 11, wherein the degree is 6.

13. An illumination system, comprising:
a light engine comprising light emitting diodes (LEDs);
a control system coupled to the light engine, the control system comprising:
a memory, and
a processor coupled to the memory, the processor configured to:
receive, from a user input device, a desired color and a desired total flux output of the light engine,
obtain, from the memory, color signature data for each LED;
obtain, from the memory, power flux data for each LED;
determine a power command for each LED based on the color signature data for each LED, the power flux data for each LED, the desired color, and the desired total flux output; and
send each power command to the LED to generate the desired color and the desired total flux output from the light engine.

14. The illumination system of claim 13, wherein:
the LEDs comprise:
a red LED comprising a red LED module and an LED drive circuit,
a green LED comprising a red LED module and an LED drive circuit, and
a blue LED comprising a red LED module and an LED drive circuit; and
the power command for each LED is a pulse-width modulation (PWM) signal that causes the LED drive circuit to output a drive current to the LED module.

15. The illumination system of claim 14, wherein the desired color comprises a Commission Internationale de l'éclairage (CIE) x value and a CIE y value.

16. The illumination system of claim 15, wherein the color signature data comprise a first color signature value and a second color signature value.

17. The illumination system of claim 16, wherein:
the first color signature value comprises a first slope of a linear fit to measured CIE X data versus measured CIE Y data; and
the second color signature value comprises a second slope of a linear fit to measured CIE Z data versus measured CIE Y data.

18. The illumination system of claim 17, wherein the measured CIE Y data define a luminance, and the measured CIE X data and the measured CIE Z data define a chromaticity.

19. The illumination system of claim 18, wherein:
the power flux data comprise polynomial parameter values that are determined based on a polynomial fit to PWM signal data provided to the LED drive circuit versus measured LED output flux data; and
the polynomial parameter values include scalar coefficients for a polynomial having a degree.

20. The illumination system of claim 13, further comprising:
a first coaxial light engine comprising LEDs, the first coaxial light engine configured to generate a first coaxial light beam; and
a second coaxial light engine comprising LEDs, the second coaxial light engine configured to generate a second coaxial light beam,
wherein the light engine is configured to generate an oblique light beam.
